(19) United States
(12) Patent Application Publication
(10) Pub. No.: US 2007/0172091 A1
(43) Pub. Date: Jul. 26, 2007

(54) Ear hook for a wireless headset and a carrying device thereof

(76) Inventors: Chia-Hsin Tsai, Taichung (TW); Chan-Wei Chang, Taichung (TW); Ke-Ming Huang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/337,522

(22) Filed: Jan. 24, 2006

(51) Int. Cl. H04R 25/00

(52) U.S. Cl. 381/381

(57) ABSTRACT

An ear hook for a wireless headset includes a carrying portion and a joint portion. The carrying portion has a first connection, a power control circuit and a battery unit, and the joint portion has a second connection. The first connection is connected with the second connection in a separate fashion. When there is a voltage input detected at the first connection, the power control circuit applies the voltage output at the first connection to charge the battery unit, and when there is no voltage input detected at the first connection, the power control circuit sets the battery unit to discharge. Therefore, when the carrying portion is connected with the joint portion, the battery unit inside the carrying portion discharges, and when the carrying portion separates from the joint portion, it is connected with a transformer via the first connection to charge the battery unit.

### BACKGROUND OF THE INVENTION

1. Field of the Invention

The present invention generally relates to an ear hook for a wireless headset, and more particularly relates to an ear hook for a wireless headset, which is provided with rechargeable power.

2. Description of the Related Art

Wireless communication products have become popular due to the fast development of wireless communication technology. For example, there are many wireless headsets commercially available for cell phone users. A wireless headset 7, as shown in FIG. 1, was designed by Sony Ericsson, and is known as model number HBH-30 on the market. Such a headset 7 comprises a body 73 and an ear hook 71. The body 73 allows users to speak wirelessly, and the ear hook 71 transmits power required by the working body 73 with its own recharging battery. When the recharging battery inside the ear hook 71 is exhausted, it can be recharged via a recharger (not shown) which is connected with a recharging plug 72 in the body 73.

For the headset 7 shown in FIG. 1, the recharging plug 72 is provided on the body 73, and therefore the user must connect it with the recharger when he/she is recharging his/her headset. Under these circumstances, the headset cannot be used simultaneously. In other words, the user cannot use his/her headset until the recharging process of the battery is completed, and thus suffers from the inconvenience caused by the recharging process. How to make the headset available to the user during its recharging process is therefore a problem to be solved.

### SUMMARY OF THE INVENTION

The present invention is proposed to eliminate the drawbacks of the prior art, and provides an ear hook for a headset and a carrying device thereof. The ear hook allows the headset to be used conveniently without the influences of recharging batteries, and has rechargeable power which is connected therewith in a separate fashion.

The ear hook in accordance with the present invention comprises a carrying portion and a joint portion. The carrying portion has a battery unit, a power control circuit and a first connection. The joint portion has a second connection demountably connected with the first connection. The power control circuit controls the recharging/discharging process of the battery unit in accordance with the voltage input at the first connection. Therefore, when the first connection is connected with the second connection, the power control circuit allows the battery unit to discharge to supply electricity for the headset. When the first connection is connected with a transformer, the power control circuit allows the transformer to recharge the battery unit.

The above-mentioned power control circuit comprises a first switch control circuit, a recharging circuit, a second switch control circuit, and a detecting circuit. The first switch control circuit controls the on/off status between the battery unit and the first connection. The recharging circuit controls the recharge process of the battery unit. The second switch control circuit controls the on/off status between the recharging circuit and the first connection. The detecting circuit detects a voltage input at the first connection. When the detecting circuit detects a voltage input at the first connection, it sets the first switch control circuit off and the second switch control circuit on, allowing the recharging circuit to recharge the battery unit. When the detecting circuit detects no voltage input at the first connection and the connection between the first and second connections, it sets the first switch control circuit on and the second switch control circuit off, allowing the battery unit to discharge via the first connection to provide electricity for the headset.

The battery unit is provided in the carrying portion of the ear hook, and the carrying portion can be separated from the joint portion of the ear hook for recharging the battery unit. If the carrying portion is connected with the joint portion, the power control circuit inside the carrying portion allows the battery unit to discharge and provide electricity to the headset. If the carrying portion is connected with the transformer, the power control circuit inside the carrying portion allows the battery unit inside the carrying portion to be recharged by the transformer. Therefore, the carrying portion can be separated from the joint portion and be recharged alone. In this way, the wireless headset can still work normally with a previously recharged carrying portion during the recharging process of the exhausted carrying portion.

### BRIEF DESCRIPTION OF THE DRAWINGS

The present invention can be fully understood from the following detailed description and preferred embodiment with reference to the accompanying drawings, in which:

FIG. 1 is a perspective view of a conventional wireless headset in accordance with prior art;

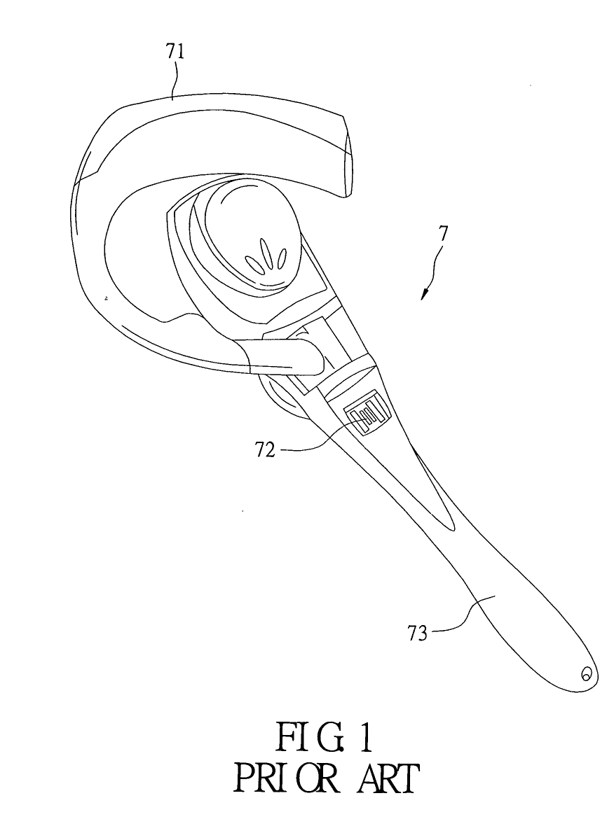

FIG. 2 is a perspective view of a wireless headset in accordance with the present invention;

FIG. 3 is an exploded, perspective view of an ear hook of the headset in FIG. 2 in accordance with the present invention;

FIG. 4 is an operational, perspective view of a carrying portion of the ear hook in FIG. 3 when the carrying portion is recharged by a transformer;

FIG. 5 is a circuit block diagram showing a power control circuit inside the ear hook in FIG. 3; and

FIG. 6 is a circuit diagram of the power control circuit in FIG. 5.

### DESCRIPTION OF THE PREFERRED EMBODIMENTS

The features and advantages of the present invention will become better understood with regard to the following embodiments.

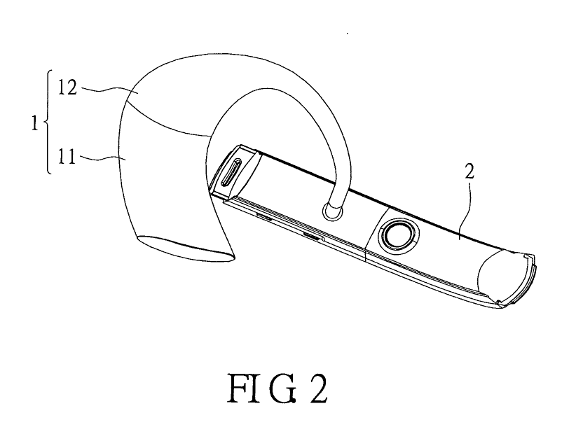

Referring to FIG. 2, a perspective view shows a wireless headset according to a preferred embodiment of the present invention. A body 2 of the wireless headset receives and emits radio signals, allowing a user to communicate in a wireless fashion. One end of an ear hook 1 of the headset is pivotally mounted with the body 2, and thus the ear hook 1 can provide power to the body 2. The ear hook 1 comprises a carrying portion 11 and a joint portion 12. The carrying portion 11 is electrically and demountably connected with the joint portion 12. Consequently, the carrying portion 11 is rechargeable and also serves as a power source. When the carrying portion 11 is exhausted, it can be separated from the joint portion 12 to be recharged. Meanwhile, the user can replace the currently exhausted carrying portion 11 with a previously charged carrying portion 11 and connect the latter with the joint portion 12. Thus the body 2 can still function normally even when the exhausted carrying portion 11 is being recharged.

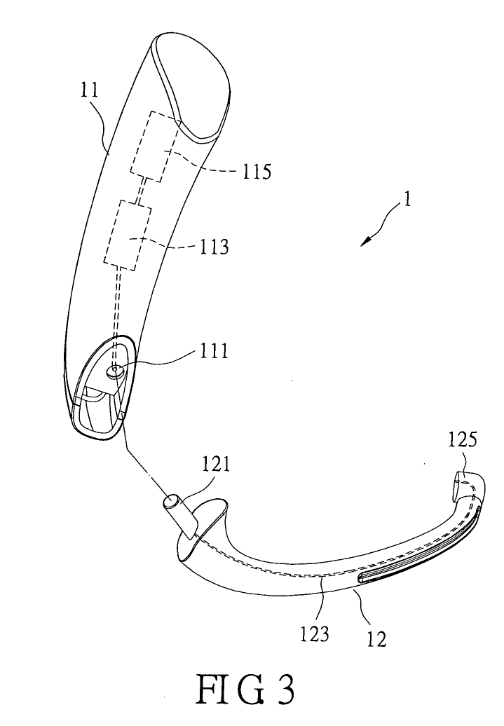

Referring to FIG. 3, the carrying portion 11 has a first connection 111, a power control circuit 113 and a battery unit 115. The power control circuit 113 is electrically connected between the first connection 111 and the battery unit 115. The power control circuit 113 detects whether there is a voltage input through the first connection 111. When a voltage input is inputted to the power control circuit 113 through the first connection 111, the power control circuit 113 controls the voltage input to recharge the battery unit 115. When there is no voltage input through the first connection 111 and the first connection 111 is connected to a second connection 121 of the joint portion 12, the power control circuit 113 controls the battery unit 115 to discharge via the first connection 111 to provide electricity for the headset through the joint portion 12. The battery unit 115 utilized in the present embodiment is substantially a rechargeable battery.

The joint portion 12 has a second connection 121, a power transmission interface 123 and a pivotal portion 125. The second connection 121 is demountably connected with the first connection 111. In the present embodiment, the first connection 111 is substantially a female plug and the second connection 121 is substantially a male plug, and thereby the carrying portion 11 can be demountably connected with the joint portion 12. Alternatively, the first connection 111 is substantially a male plug, and the second connection 121 is substantially a female plug, and thereby the carrying portion 11 can be also demountably connected with the joint portion 12. The power transmission interface 123 is electrically connected with the second connection 121 to transmit electricity.

The power transmission interface 123 is a wire in the present embodiment. The pivotal portion 125 is provided at one end of the joint portion 12 and pivotally mounted with the body 2 as shown in FIG. 2. The connection allows the power transmission interface 123 transmitting electricity to the body 2. Therefore, when the first connection 111 of the carrying portion 11 is connected with the second connection 121 of the joint portion 12, the power control circuit detects no voltage input at the first connection 111, and controls the battery unit 115 of the carrying portion 11 to discharge. The power is transmitted from the battery unit 115 to the body 2 by means of the power transmission interface 123.

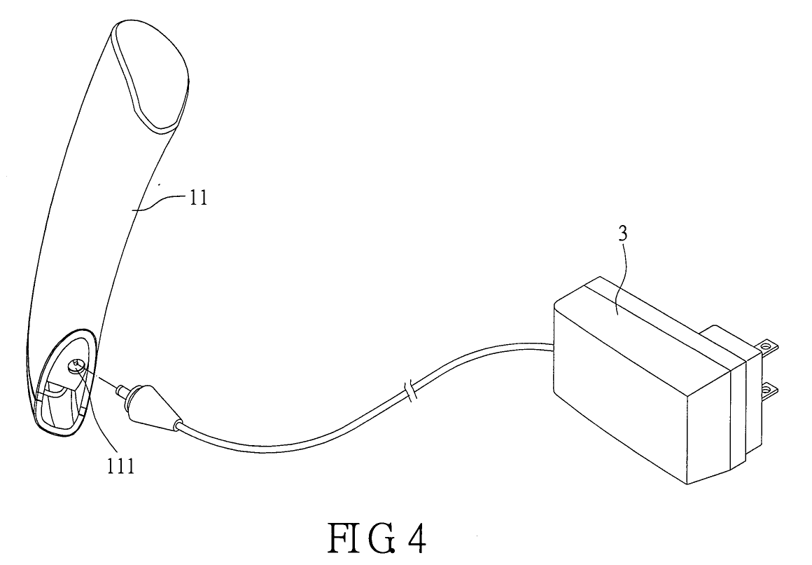

Referring to FIG. 4, when the carrying portion 11 needs to be recharged, the user can demount the carrying portion 11 from the joint portion 12, and use a transformer 3 to recharge the carrying portion 11 by inserting a plug of the transformer 3 into the first connection 111 of the carrying portion 11. When the transformer 3 is inserted into a wall socket, it sends a voltage input to the first connection 111. Once the power control circuit 113 of the carrying portion 11 detects the voltage input at the first connection 111, it arranges the recharging process for the battery unit 115 inside the carrying portion 11.

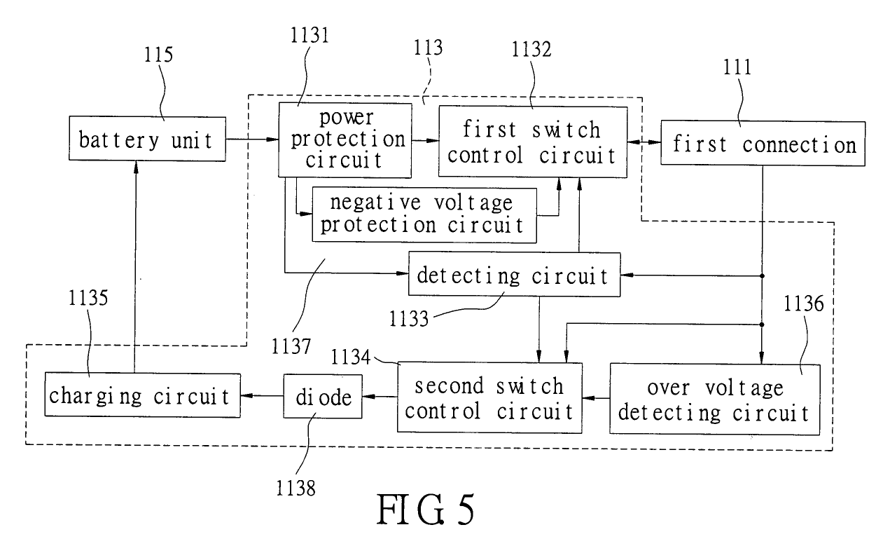

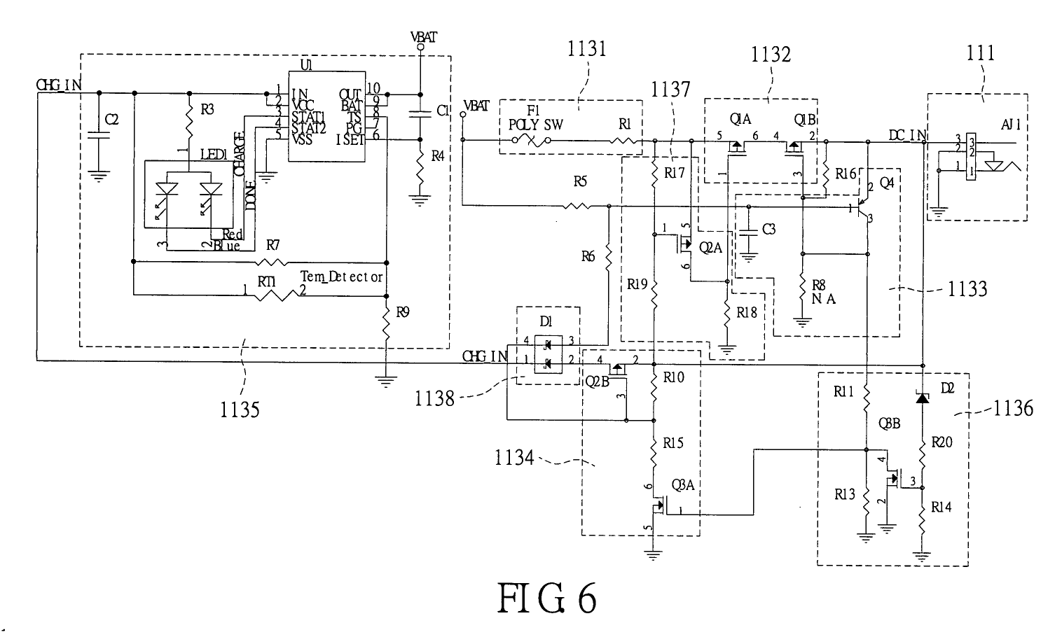

Referring to FIGS. 5 and 6, the power control circuit 113 comprises a protection circuit 1131, a first switch control circuit 1132, a detecting circuit 1133, a second switch control circuit 1134, a charging circuit 1135, an over voltage detecting circuit 1136, a negative voltage protection circuit 1137 and a diode 138. The protection circuit 1131 is electrically connected with the battery unit 115 and protects the battery unit 115 from outputting excessively voltage/current. The protection circuit 1131 comprises an over current protection element for detecting if the current outputted from the battery unit 115 is excessive, as well as an over voltage protection element for detecting if the voltage outputted from the battery unit 115 is excessive. The over current protection element is a fuse F₁ and the over voltage protection element is a resistance R₁, according to the embodiment.

The first switch control circuit 1132 controls the on/off status between the battery unit 115 and the first connection 111. Therefore, when the first switch control circuit 1132 is on, the voltage outputted by the battery unit 115, V_{BAT}, is able to discharge through the first connection 111 to the joint portion 12. When the first switch control circuit 1132 is off, the voltage outputted by the battery unit 115, V_{BAT}, is unable to discharge through the first connection 111. The second switch control circuit 1134 controls the on/off status between the charging circuit 1135 and the first connection 111. Therefore, when the second switch control circuit 1134 is on, the voltage input at the first connection 111 is applied to the recharging circuit 1135, and the recharging circuit 1135 can recharge the battery unit 115 in accordance to such a voltage input. Also, when the second switch control circuit 1134 is off, the charging circuit 1135 is unable to recharge the battery unit 115 since the voltage outputted by the first connection 111 is not applied thereto.

The detecting circuit 1133 is used to control the on/off status of the first switch control circuit 1132 and the second switch control circuit 1134 respectively. The detecting circuit 1133 can detect whether there is a voltage input at the first connection 111. If there is a voltage input at the first connection 111, the detecting circuit 1133 sets the first switch control circuit 1132 off and the second switch control circuit 1134 on, allowing the battery unit 115 to be recharged. If there is no voltage input at the first connection 111 and the first and the second connections are connected, the detecting circuit 1133 sets the first switch control circuit 1132 on and the second switch control circuit 1134 off, allowing the battery unit 115 to discharge through the joint portion 12.

The over voltage detecting circuit 1136 is electrically connected between the second switch control circuit 1134 and the first connection 111. The over voltage detecting circuit 1136 is used to detect whether the voltage at the first connection 111 exceeds a predetermined value. If it does, the detecting circuit 1133 detects the voltage input at the first connection 111 and then sets the second switch control circuit 1134 on. But it sets the status between the first connection 111 and the second switch control circuit 1134 off to prevent the second switch control circuit 1134 from obtaining the voltage inputted from the first connection 111 via the over voltage detecting circuit 1136, thereby avoiding the excessive voltage inputted from the first connection 111 jeopardizing the normal function of the charging circuit 1135. If the voltage at the first connection is within a normal range of predetermined values, the over voltage detecting circuit 1136 sets the status between the first connection 111 and the second switch control circuit 1134 on, and thus the second switch control circuit 1134 can obtain the voltage inputted from the first connection 111, allowing the charging circuit 1135 to be charged normally.

The negative voltage protection circuit 1137 is electrically connected between the power protection circuit 1131 and the first switch control circuit 1132. A diode 1138 is electrically connected between the charging circuit 1135 and the second switch control circuit 1134. When a negative voltage is applied to the first connection 111, the negative voltage protection circuit 1137 and the diode 1138 protect the entire circuit, and prevent abnormal current from reversibly traveling to the electronic components in the power control circuit 113 to avoid jeopardizing the life cycle all the components.

As mentioned above, the separable design of the two portions 11, 12 is adopted in this ear hook for a headset in the preferred embodiment. Consequently, the carrying portion 11 can be connected with or separated from the second connection 121 of the joint portion 12. When the carrying portion 11 is connected with the joint portion 12, the battery unit 115 inside the first connection 111 will discharge, allowing the body 2 to obtain the required power to maintain its function.

According to the preferred embodiment, one of the advantages of the separable design for the carrying portion 11 is to keep the body 2 working normally even during its recharging process. Furthermore, the carrying portion 11 can be recharged, and the carrying portion can be separated from the joint portion 12 and recharged when it is exhausted. Meanwhile, the body 2 can still work normally after a previously recharged carrying portion 11 is connected with the joint portion 12.

Additionally, the carrying portion 11 is controlled via the power control circuit 113. Either recharging or discharging is processed via the first connection 111. Another advantage of the preferred embodiment is to avoid unnecessary plugs, and thus simplify the whole structure of the ear hook.

In view of the foregoing, the present invention is believed to be useful, novel and unobvious. Meanwhile, it should be noted that people skilled in the art can obtain various modifications without departing from the spirit and the scope of the appended claims.

What is claimed is:

1. An ear hook for a wireless headset, the ear hook comprising:
a carrying portion having a battery unit, a power control circuit and a first connection; and
a joint portion having a second connection, and the second connection demountably connected with the first connection;
wherein when the first connection is connected with the second connection, the power control circuit allows the battery unit to discharge;
and when the first connection receives a voltage input, the power control circuit allows the battery unit to be recharged.

2. The ear hook as recited in claim 1, wherein the battery unit is a rechargeable battery.

3. The ear hook as recited in claim 1, wherein the power control circuit comprises:
a first switch control circuit for controlling the on/off status between the battery unit and the first connection;
a recharging circuit for recharging the battery unit;
a second switch control circuit for controlling the on/off status between the charging circuit and the first connection; and
a detecting circuit for detecting the voltage input status at the first connection;
wherein when the detecting circuit detects the voltage input at the first connection, the detecting circuit sets the first switch control circuit off and the second switch control circuit on, allowing the charging circuit to recharge the battery unit, and when the detecting circuit detects no voltage input at the first connection, the detecting circuit sets the first switch control circuit on and the second switch control circuit off, allowing the battery unit to discharge through the first connection.

4. The ear hook as recited in claim 3, wherein the power control circuit further comprises:
a protection circuit electrically connected with the battery unit.

5. The ear hook as recited in claim 4, wherein the protection circuit comprises an over current protection element and/or an over voltage protection element.

6. The ear hook as recited in claim 4, wherein the power control circuit further comprises:
a negative voltage protection circuit electrically connected between the protection circuit and the first switch control circuit.

7. The ear hook as recited in claim 3, wherein the power control circuit further comprises:
a diode electrically connected between the charging circuit and the second switch control circuit.

8. The ear hook as recited in claim 3, wherein the power control circuit further comprises:
an over voltage detecting circuit electrically connected between the first connection and the second connection, for detecting the voltage input status at the first connection, and the on/off status between the first connection and the second connection in accordance with the detected result.

9. The ear hook as recited in claim 1, wherein the first connection and the second connection are a female plug and a male plug respectively.

10. The ear hook as recited in claim 1, wherein one end of the joint portion is provided with a pivoting portion connected with the wireless headset.

11. The ear hook as recited in claim 1, wherein the joint portion is provided with a power transmission interface electrically connected with the second connection.

12. A carrying device of an ear hook, the carrying device comprising:
a battery unit;
a connection; and
a power control circuit for controlling the charging/discharging operations of the battery unit, the power control circuit electrically connected between the battery unit and the connection.

13. The carrying device as recited in claim 12, wherein the battery unit is a recharging battery.

14. The carrying device as recited in claim 12, wherein the power control circuit comprises:
a first switch control circuit for controlling the on/off status between the battery unit and the connection;
a recharging circuit for recharging the battery unit;
a second switch control circuit for controlling the on/off status between the recharging circuit and the connection; and
a detecting circuit for detecting a voltage input through the connection;
wherein when the detecting circuit detects the voltage input at the connection, the detecting circuit sets the first switch control circuit off and the second switch control circuit on, allowing the recharging circuit to recharge the battery unit, and when the detecting circuit detects no voltage input at the connection, the detecting circuit sets the first switch control circuit on and the second switch control circuit off, allowing the battery unit to discharge through the first connection.

15. The carrying device as recited in claim 14, wherein the power control circuit comprises:
a protection circuit electrically connected with the battery unit.

16. The carrying device as recited in claim 15, wherein the protection circuit comprises an over circuit protection element and/or an over voltage protection element.

17. The carrying device as recited in claim 15, wherein the protection circuit further comprises:
a negative voltage protection circuit electrically connected between the protection circuit and the first switch control circuit.

18. The carrying device as recited in claim 15, wherein the power control circuit further comprises:
a diode electrically connected between the recharging circuit and the second switch control circuit.

19. The carrying device as recited in claim 15, wherein the power control circuit further comprises:
an over voltage detecting circuit electrically connected between the connection and the second switch control circuit, the voltage detecting circuit detecting the voltage input at the connection and determining the on/off status between the connection and the second switch control circuit in accordance with the detected result.

20. The carrying device as recited in claim 12, wherein the connection is selected from one of a female plug or a male plug.
